(19) United States
(12) Patent Application Publication
(10) Pub. No.: US 2013/0006555 A1
(43) Pub. Date: Jan. 3, 2013

(54) METHOD AND APPARATUS FOR MEASURING THE POWER OF A POWER GENERATOR WHILE OPERATING IN VARIABLE FREQUENCY MODE AND/OR WHILE OPERATING IN PULSING MODE

(75) Inventors: Jeff (Jeffrey) Roberg, Longmont, CO (US); Joel Blackburn, Fort Collins, CO (US)

(73) Assignee: Advanced Energy Industries, Inc., Ft. Collins, CO (US)

(21) Appl. No.: 13/173,355

(22) Filed: Jun. 30, 2011

(51) Int. Cl. G06F 19/00

(52) U.S. Cl. 702/61

(57) ABSTRACT

Methods and apparatuses are disclosed for measuring electrical characteristics of power that is applied to a plasma processing chamber when the electrical generator operates in a pulsing mode, when the electrical generator operates in a variable frequency mode, and when the electrical generator operates in both a pulsing mode and in a variable frequency mode concurrently.

### FIELD

The present disclosure relates generally to electrical generators. In particular, but not by way of limitation, the present disclosure relates to methods and apparatuses for measuring electrical characteristics of power that is applied to a plasma processing chamber.

### BACKGROUND

In plasma processing applications, such as the manufacture of semiconductors or flat panel displays, RF power generators apply a voltage to a load in a plasma chamber and may operate over a wide range of frequencies. Experience in the plasma-processing industry has been able to associate particular plasma parameters (e.g., ion density, electron density, and energy distribution) to characteristics (e.g., uniformity, film thickness, and contamination levels) of the processed material (e.g., wafer). In addition, a large body of knowledge exists that connects wafer characteristics to overall quality; thus there is experience in the plasma-processing industry that associates plasma parameters to the quality of the overall processing.

Obtaining information about plasma parameters (e.g., by direct measurement of the plasma environment), however, is difficult and intrusive. In contrast, identifying electrical characteristics (e.g., voltage, current, phase, impedance, power, reflected power, etc.) of power (especially radio frequency (RF) power) that is applied to a plasma processing chamber is a relatively inexpensive way to obtain a large amount of such information. Prior techniques for identifying electrical characteristics are too expensive, too slow, or too inaccurate to provide a sufficient amount of information to establish a known and repeatable association between the electrical characteristics and plasma parameters.

Matching networks are typically used to match the impedance of a load with a source to maximize power transfer. Power generators provide this functionality to users for, among other things, RF power applications. In such operation, the power generation system makes periodic measurements of RF impedance while adjusting the matching circuit so that reflected power can be minimized.

Some power generation systems include an impedance probe for measuring power and impedance at the output of the matching network. In such applications, these measurements are made on a continuous basis, which means that when power is delivered in a pulsing mode of operation, measurements are collected during pulse-off periods, which causes inaccurate reporting and therefore inaccurate control of the match tuning algorithm. These measurements are also made for a fixed operating frequency that is programmed, based on the specific application.

Users of RF power generators are incorporating pulsing RF energy in their processes at an increasing rate. Additionally, operating in a mode where the frequency of the power generator varies, also referred to as “frequency sweeping”, is being used extensively for both macro impedance adjustment (used with fixed matching applications that rely solely on frequency tuning) as well as micro impedance adjustment (traditional auto-match applications which use frequency tuning to provide matching during fast, periodic impedance changes due to influences, such as magnetic field perturbation). Additionally, frequency sweeping may also be used to influence plasma stability.

In many of these applications, it is not practicable or desirable to have a link between the power generator and the matching network to communicate the operational frequency and pulse on/off state of the generator to the matching network. Cabling required for such communication links is neither desirable nor standardized, and it is not achievable in some fabrication environments. Moreover, such communications methods have inherent delays that affect their ability to deliver timely and accurate information to the matching network. Accordingly, there is a need to improve power measurement techniques.

### SUMMARY

Illustrative embodiments of the present disclosure are shown in the drawings and summarized below. These and other embodiments are more fully described in the Detailed Description section. It is to be understood, however, that there is no intention to limit the claims herein to the forms described in this Summary or in the Detailed Description. One skilled in the art can recognize that there are numerous modifications, equivalents, and alternative constructions that fall within the spirit and scope of the present disclosure as expressed in the claims.

Disclosed herein are novel methods and apparatuses to enable a matching network to detect: (1) whether the power generator's pulse state is on or off, (2) the power generator's operating frequency, and (3) the power generator's operating frequency and whether power generator's pulse state is on or off concurrently.

As previously stated, the above-described embodiments and implementations are for illustration purposes only. Numerous other embodiments, implementations, and details of the disclosed technology are easily recognized by those of skill in the art from the following Detailed Description, referenced Figures, and Claims.

### BRIEF DESCRIPTION OF THE DRAWINGS

Various objects and advantages and a more complete understanding of the present disclosure are apparent and more readily appreciated by reference to the following Detailed Description and to the appended Claims, when taken in conjunction with the accompanying Drawings, wherein:

FIG. 1 is a block diagram depicting a plasma processing environment in which several embodiments of the present disclosure are implemented;

FIG. 2A is a diagram depicting the signal generated by a power generator when operating in a pulsing mode;

FIG. 2B is a diagram depicting the amplitude or power of the signal generated by a power generator when operating in a pulsing mode depicted in FIG. 2A;

FIG. 3 is a flowchart that depicts an exemplary method for determining the state (pulse-on or pulse-off) of a pulsing power signal that is applied to a plasma load;

FIG. 4 is a block diagram depicting an exemplary embodiment of a processing portion of the sensors described with reference to FIG. 1;

FIG. 5 is a flowchart that depicts an exemplary method for monitoring power that is applied to a plasma load;

FIG. 6 is a block diagram depicting an exemplary embodiment of the transform portion depicted in FIG. 4;

FIG. 7 is a flowchart depicting an exemplary method for performing a transform of sampled RF data;

FIG. 8 is a block diagram depicting an exemplary embodiment of the portion of the disclosure that determines the frequency at which the power generator is operating;

FIG. 9 is a flowchart depicting an exemplary method for determining the frequency at which the power generator is operating;

FIG. 10 is a block diagram depicting an exemplary embodiment of the portion of the disclosure that determines the both (1) whether or not the power generator is delivering a signal, and (2) the frequency at which the power generator is operating;

FIG. 11 is a flowchart depicting an exemplary method for determining the frequency both (1) whether or not the power generator is delivering a signal, and (2) the frequency at which the power generator is operating;

### DETAILED DESCRIPTION

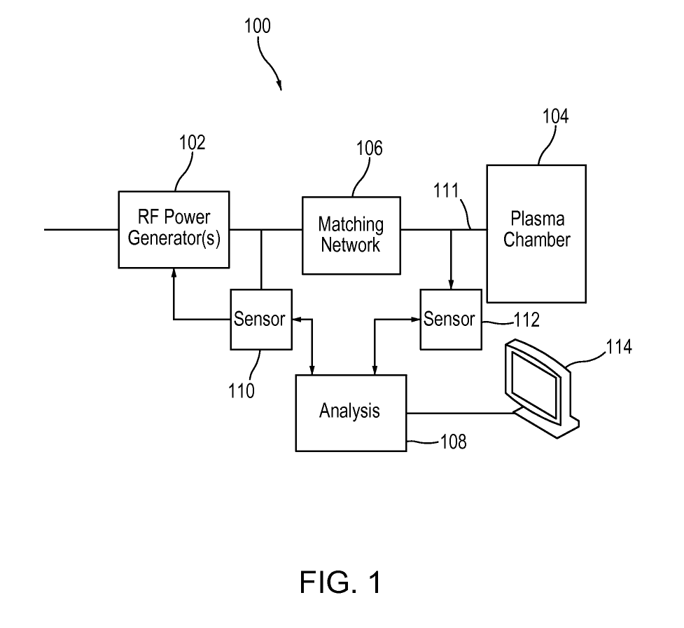

Referring now to the drawings, where like or similar elements are designated with identical reference numerals throughout the several views, and referring in particular to FIG. 1, presented is a block diagram depicting a plasma processing environment (or system) 100 in which several embodiments of the present disclosure are implemented. As shown, a power generator 102 is coupled to a plasma chamber 104 via an impedance matching network 106. Note that in some variations of the system 100, there may be more than one power generator 102. Additionally, the power generator 102 may be of the type configured to deliver radio frequency (RF) power. An analysis portion 108 of the system 100 is disposed to receive an input from a first sensor 110 that is coupled to an output of the power generator 102. The analysis portion 108 is also disposed to receive an input from a second sensor 112 that is coupled to an input of the plasma chamber 104. As depicted, the analysis portion 108 is also coupled to a man-machine interface 114, which may include a keyboard, display and pointing device (e.g., a mouse).

The illustrated arrangement of these components is functional and not meant to be an actual hardware diagram; thus, the components can be combined or further separated in an actual implementation. For example, the functionality of one or both of the sensors 110, 112 may be implemented within the matching network 106, or with components of the analysis portion 108. Alternatively, the first sensor 110 may be entirely contained within a housing of the power generator 102. One skilled in the art will readily appreciate that numerous other possibilities exist for allocation of the functionalities disclosed in FIG. 1. Moreover, it should be recognized that the components included in FIG. 1 depict an exemplary implementation, and in other embodiments, as discussed further herein, some components may be omitted and/or other components may be added to the system 100.

The power generator 102 generally provides power to the plasma chamber 104 to ignite and sustain a plasma in the chamber 104 for plasma processing. Typically such power is RF power. Although not required, in many embodiments the power generator 102 is realized by a collection of two or more power generators 102, and each of the power generators 102 provides power at a different frequency. Although certainly not required, the power generator 102 may be realized by one or more RF power generators available from Advanced Energy Incorporated in Fort Collins, Colo.

The matching network 106 in this embodiment is generally configured to transform the chamber impedance, which can vary with the frequency of this applied voltage, chamber pressure, gas composition, and the target or substrate material, to an ideal load for the power generator 102. One of ordinary skill in the art will appreciate that a variety of different matching network types may be used for this purpose. The matching network 106 may be realized by a NAVIGATOR model digital impedance matching network available from Advanced Energy Incorporated in Fort Collins, Colo., but other impedance matching networks 106 may also be employed.

The first sensor 110 in this embodiment is generally configured to provide feedback to the power generator 102 so as to enable the power generator 102 to maintain a desired level of output power (e.g., a constant output power). In one embodiment for example, the first sensor 110 measures a parameter of the electrical characteristics applied by the generator (e.g., reflected power, reflection coefficient, etc.) and provides feedback to the power generator 102 based upon a difference between the measured parameter and a predetermined setpoint.

The second sensor 112 in the embodiment depicted in FIG. 1 is generally configured to provide a characterization of the plasma in the plasma chamber 104. For example, measurements taken by the second sensor 112 may be used to estimate ion energy distribution, electron density, energy distribution, a combination of such parameters or other parameters, which affect or indicate the stability of the plasma and the results of the processing in the plasma chamber 104.

In many embodiments, by way of further example, electrical characteristics (e.g., voltage, current, impedance, phase) measured at an input 111 to the plasma chamber 104 can be used to predict values of associated plasma parameters, and those measured electrical characteristics may be used for end-point detection. For example, measurements from the second sensor 112 may be used in connection with known information (e.g., information indicating how a deviation from a particular voltage would, or would not, affect one or more plasma parameter(s)). Although not depicted in FIG. 1, the sensors 110, 112 may include one or more transducers, electronics, and processing logic (e.g., instructions embodied in software, hardware, firmware or a combination thereof).

The analysis portion 108 is generally configured to receive information (e.g., information about parameters of electrical characteristics) from the sensors 110, 112, process the information when applicable, and convey the information to a user via the man-machine interface 114. The analysis portion 108 may be realized by a general purpose computer in connection with software, or dedicated hardware and/or firmware.

Although there is illustrated and described in FIG. 1 specific structure and details of operation, it is plainly understood that such structures and details are presented merely for purposes of illustration and that changes and modifications may be readily made therein by those skilled in the art without departing from the spirit and the scope of the present disclosure.

The disclosed methods and apparatuses herein provide information to the matching network 106 to allow the matching network 106 to determine more accurately the adjustments it must make to achieve acceptable performance of the system 100. The disclosed technology herein may operate in the input side of the matching network 106 (e.g., in the first sensor 110), the output side of the matching network 106 (e.g., in the second sensor 112) or at other portions of the system 100 (e.g., the functionality disclosed herein may be realized in components distributed about the system 100).

Embodiments of the disclosed technology herein may operate in various modes of operation including: a pulsing mode of operation, a variable frequency mode of operation, and a mode of operation in which the pulsing and variable frequency modes are operating concurrently.

A first portion of the present disclosure is directed to a method for determining—continuously, automatically, and autonomously—whether or not the power generator 102 is delivering a power signal into the plasma chamber 104.

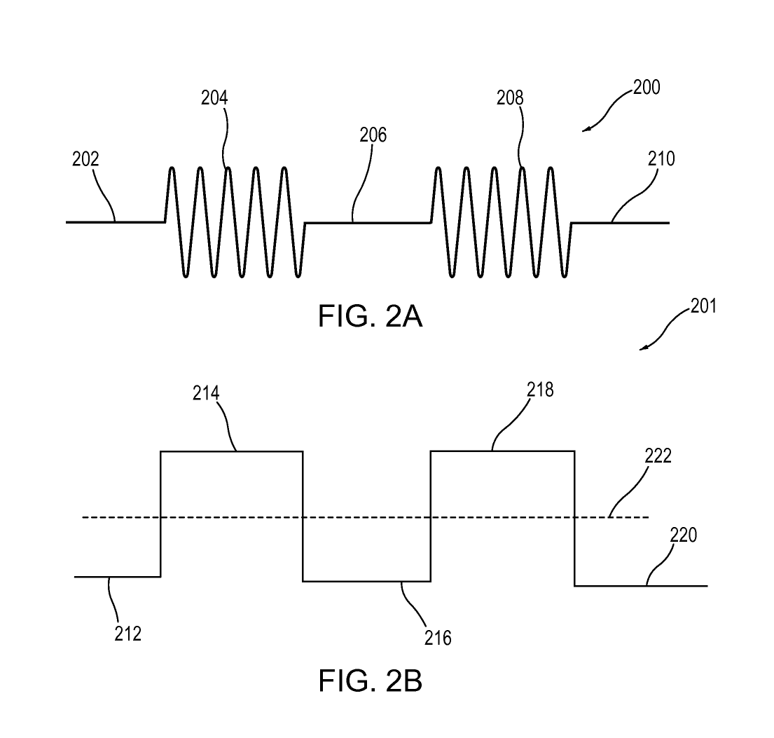

Referring to FIG. 2A, depicted is an illustrative example of a pulsing signal 200 generated by the power generator 102 as well as the voltage or power of that signal. Typically, but not always, the power signal delivered by the power generator 102 is a sinusoidal signal, as illustrated at portions 204 and 208 of the pulsing signal 200, corresponding to a pulse-on state of the power generator 102. Initially, the power generator 102 is idle (corresponding to portion 202), which indicates that the power generator 102 is generating no signal. When the power generator 102 is configured to operate in a pulsing mode, the power generator 102 delivers a power signal 204 to the plasma chamber 104 for a first period of time. Then the power generator 102 stops delivering a power signal to the plasma chamber 104 for a period of time, corresponding to portion 206 of the pulsing signal 200. Next the power generator 102 resumes delivering a power signal to the plasma chamber for another period of time, corresponding to portion 208 of the pulsing signal 200. When operating in the pulsing mode, the system 100 continues to operate in this fashion. Accordingly, when the power generator 102 operates in a pulsing mode, the amplitude of the power signal 200 delivered by the power generator 102 alternates between being high (corresponding to the pulse-on state 204, 208) and then low (corresponding to the pulse-off state 202, 206, 210).

Often, but not always, the periods of time for the pulse-on states 204, 208 and pulse-off states 202, 206, 210 remain constant. However, the pulse-on 204, 208 and pulse-off 202, 206, 210 durations may vary—over time and with respect to each other—to achieve the desired results from the plasma. Accordingly, there is a need to continuously monitor the power generator's 102 state (e.g., the pulse-on 204, 208 or pulse-off 202, 206, 210 state) when the generator 102 operates in a pulsing mode.

The methods and apparatuses disclosed herein for detecting whether the power generator 102 is in the pulse-on 204, 208 or pulse-off 202, 206, 210 state include making measurements (continuous or substantially continuous measurements) of either the amplitude or of the power of the pulsing signal 200 generated by the power generator 102.

Referring to FIG. 2B, depicted is a signal 201 reflecting the measured amplitude or power of the pulsing signal 200. In many implementations continuous measurements of the amplitude or of the power of the pulsing signal 200 may be taken according to one or more techniques (one of which is described in detail below). In one embodiment, the pulsing signal's 200 amplitude or power is digitally sampled at an appropriate sampling rate. In another embodiment, the pulsing signal's 200 amplitude or power is measured with analog circuitry to make continuous measurements of the amplitude or power of the pulsing signal 200 generated by the power generator 102.

More particularly, portion 212 of the measured signal 201 corresponds to portion 202 of the pulsing signal 200, where no power is being generated by the power generator 102. Similarly, portions 214, 216, 218 and 220 of the measured signal 201 correspond to portions 204, 206, 208 and 210, respectively, of the pulsing signal 200.

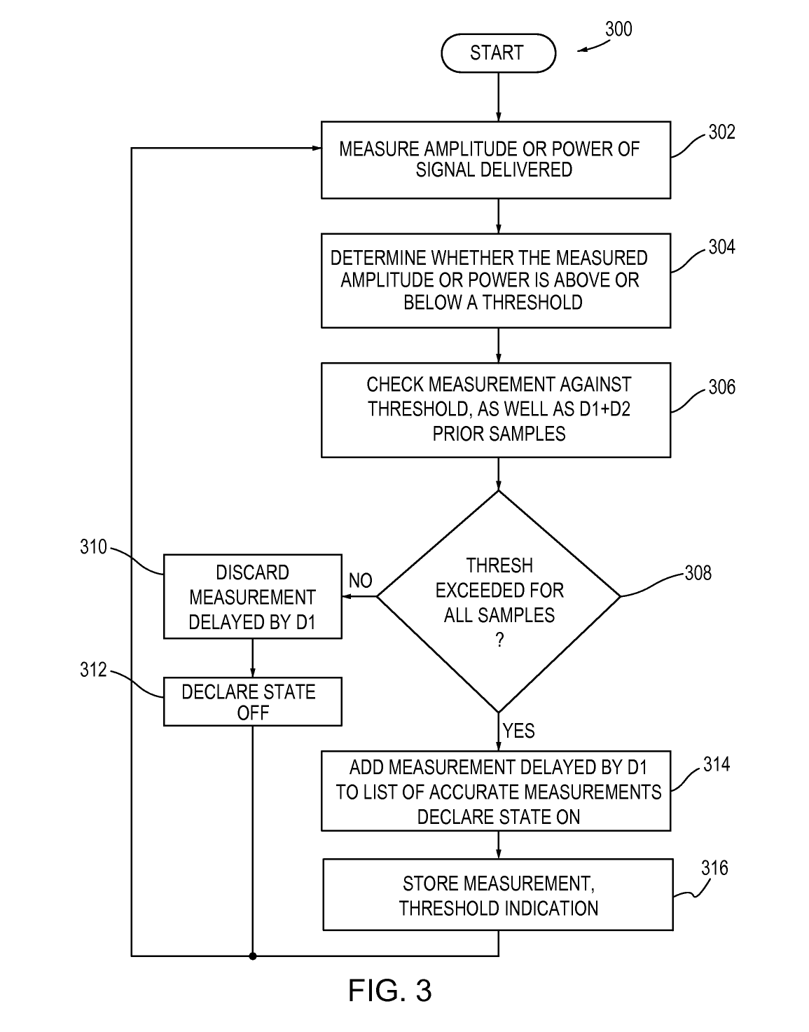

While referring to FIGS. 2A and 2B, simultaneous reference will be made to FIG. 3, which is a flowchart 300 that depicts an exemplary method for determining whether the power generator 102 is in the pulse-on state 204, 208, or whether the power generator 102 is in the pulse-off state 206, 210. It should be recognized, however, that the method depicted in FIG. 3 is not limited to the specific embodiments depicted herein.

As shown in FIG. 3 at blocks 300 and 302, the power signal 200 that is generated by the power generator 102 is measured (e.g., by one or both sensors 110, 112) to obtain either the amplitude or the power of the signal 200.

At block 304 a predetermined threshold 222 is used to determine whether or not the power generator 102 is presently delivering a power signal to the plasma chamber 104. In one embodiment, the predetermined threshold 222 is programmable. An assessment is made as to whether the measured signal 201 is above or below the predetermined threshold 222 to make such a determination. If the measured signal 201 is above the predetermined threshold 222, then (excluding confounding factors such as noise or delays in the system 100) the power generator 102 is in the pulse-on state 204, 208; if the measured signal is below the predetermined threshold 222, then the power generator 102 is in the pulse-off state 202, 206, 210 (again, excluding confounding factors such as noise or delays in the system 100).

The disclosed technology also takes into consideration delay and signal noise when the pulsing signal 200 transitions between the pulse-on state 204, 208 and pulse-offstate 202, 206, 210. In particular, a predetermined (and programmable) number of consecutive measurements above the threshold 222 may be looked for (e.g., by processing components in the analysis portion 108). The disclosed method 300 features an option to discard one or more measurements at the end of a particular state, recognizing that such measurements are susceptible to false readings due to noise generated during the transition between states, and due to uncertainty of the measurement relative to the transition from one state to the other (block 306).

In particular, at the end of the pulse-on state 204, 208, it is possible for noise to be generated which can lead to false readings of high, when in fact the power generator 102 has already stopped delivering power to the plasma chamber 104. Additionally, there is a risk that a partial measurement is recorded during the fall time of the pulse from the pulse-on state 204, 208 to the pulse-off state 202, 206, 210. Accordingly, the method disclosed herein looks for some number (which may be programmable) of consecutive samples that are above the predetermined threshold 222, then it discards some number (again, which may be programmable) of the most recent measurements to account for potential false high measurements due to noise occurring at transition points or due to measurement errors that may occur at such transition points (block 306).

One illustrative example of the disclosed means for accounting for noise and delay in the measurements is implemented as follows: The measurements are designated as m(n), m(n+1), m(n+2), etc. Delay measurements are also stored, and they are designated as m(n−1), m(n−2), etc. For each interval, the measurement m(n) is considered to be valid if all samples from m(n−D₂) to m(n+D₁) are above the predetermined threshold 222. The determination for m(n) cannot be made until the m(n+D₁) sample is received so this implies that D₁ delayed measurements and D₁+D₂ threshold indications are stored. The result from this algorithm is that measurements are only valid if they satisfy the following three conditions: (1) the measurement is above the predefined threshold; (2) D₁ samples after the measurement are above the threshold; and (3) D₂ samples before the measurement are above the threshold. By checking samples before and after each measurement, measurements that are taken close to the transition between the pulse-on state 204, 208 and the pulse-off state 206, 210 can be discarded (blocks 306, 308, 310, 312, 314, and 316) to improve accuracy of the threshold detection.

In addition to the improvements in threshold detection previously discussed, it is desirable to discard samples near transition states to improve the accuracy of the measurement. In the context of improvements of measurement accuracy, it is most appropriate to discuss samples as groups of individual measurements designated as M(i) where M(i) represents a collection of individual samples m(1) . . . m(n) which are used to calculate a measurement result. Near pulse-on or pulse-off transition states, variances in the amplitude of the measured signals m(n) can cause inaccuracy of the group M(i). These amplitude variances can be the result of dynamics of the plasma load or ramp and/or decay rates of the power generator. The number of groups of samples discarded after the detection of a pulse-on state (e.g. by comparison of measurements against a predetermined threshold) is designated as E₁ and the number of groups of samples discarded prior to the detection of a pulse-off state is designated as E₂. In one embodiment, E₁ and E₂ could be programmed based on prior knowledge of the dynamics of the signal to be measured. In this instance, groups of samples are considered valid if they fall between M(ON+E₁) and M(OFF-E₂) where M(ON) represents the first valid group of samples after the detection of pulse-on and M(OFF) represents the last valid group of samples prior to the detection of pulse-off. In another embodiment, E₁ and E₂ could be dynamically determined by calculating the variance (V₁, V₂, . . . ) and discarding measurement groups that are pulse-off (e.g. measurement is below the predetermined threshold), or that have high variance (e.g. V—above a predetermined threshold). The method to calculate the variance can use a variety of algorithms, with standard deviation as one possible method.

The remaining (not discarded) measurements are the ones that are used to inform the matching network 106 of the present operational state of the power generator 102 within the system 100 (blocks 312 and 314). By knowing whether the power generator 102 is in the pulse-on state 204, 208 or pulse-off state 202, 206, 210, the matching network 106 is able to adjust its circuitry to accurately match the impedance of the load in the plasma chamber 104 with the power generator 102, to minimize reflected power and thereby maximize power transfer.

In one embodiment, the method for making continual power measurements uses a technique described in U.S. Patent Application Publication Number 2009/0167290, “System, Method, and Apparatus for Monitoring Characteristics of RF Power,” filed by Brouk et at., and published on Jul. 2, 2009, which is incorporated into this disclosure by reference. These measurements are frequency selective, and they occur in real-time at a rate that enables multiple measurements during the shortest allowed pulse-on time.

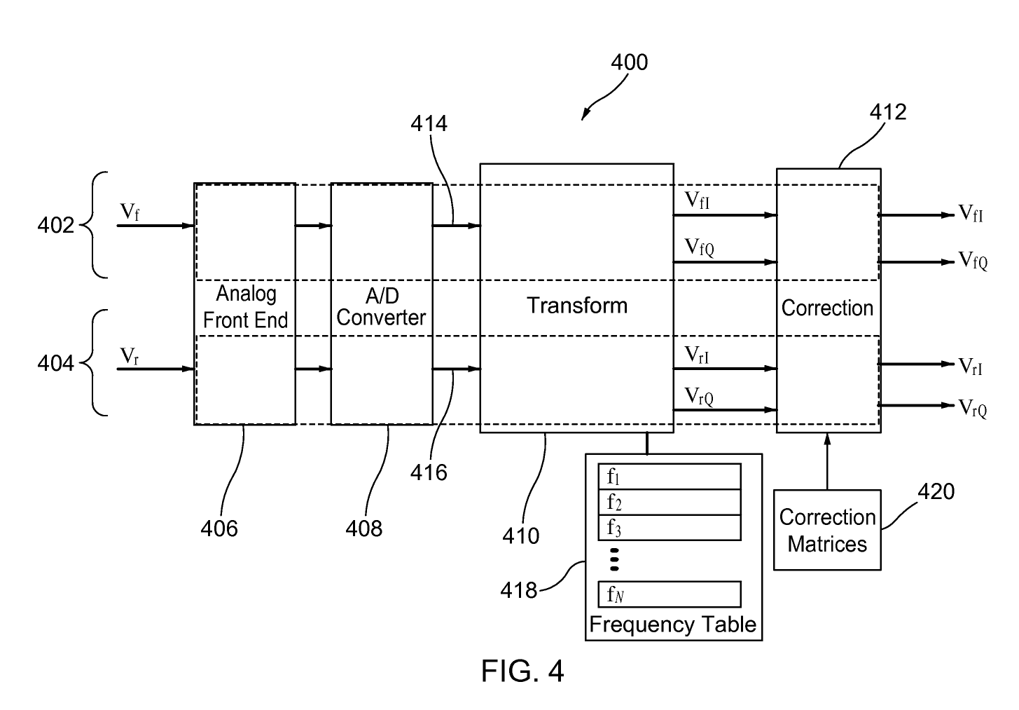

Referring next to FIG. 4, shown is an exemplary embodiment of a processing portion 400, which may be implemented as part of the sensors 110, 112 and/or the analysis portion 108 described with reference to FIG. 1. As shown, the processing portion 400 in this embodiment includes a first processing chain 402 and a second processing chain 404, and each processing chain 402, 404 includes an analog front end 406, an analog to digital (A/D) converter 408, a transform portion 410, and a correction portion 412.

The depiction of components in FIG. 4 is logical and not meant to be an actual hardware diagram; thus, the components can be combined or further separated in an actual implementation. For example, the A/D converter 408 may be realized by two separate A/D converters (e.g., 14 bit converters), and the transform portion 410 may be realized by a collection of hardware, firmware, and/or software components. In one particular embodiment for example, the transform and correction portions 410, 412 are realized by a field programmable gate array (FPGA).

In the exemplary embodiment depicted in FIG. 4, the first and second processing chains 402, 404 are configured to receive respective forward-voltage and reverse-voltage analog-RF signals (e.g., from a directional coupler, which may be referred to as a forward and reflected wave sensor). In other embodiments the first and second processing chains 402, 404 may receive voltage and current analog-RF signals. For clarity, the operation of the processing portion 400 is described with reference to a single processing chain, but it should be recognized that corresponding functions in one or more additional processing chains are carried out.

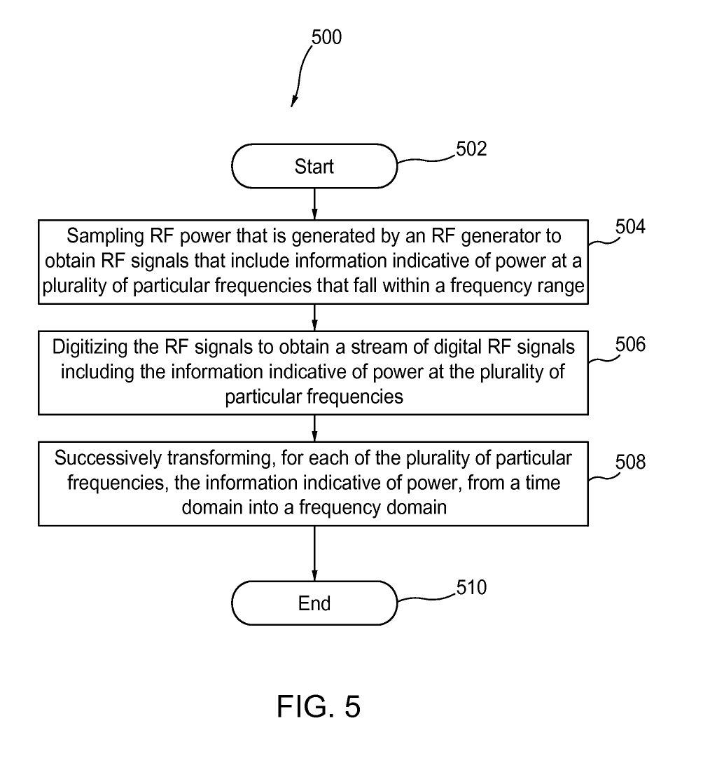

While referring to FIG. 4, simultaneous reference will be made to FIG. 5, which is a flowchart 500 that depicts an exemplary method for monitoring electrical characteristics of power that is applied to a plasma load. It should be recognized, however, that the method depicted in FIG. 5 is not limited to the specific embodiment depicted in FIG. 4. As shown in FIG. 5, power that is generated by a power generator (e.g., the power generator 102) is sampled to obtain signals that include information indicative of electrical characteristics at a plurality of particular frequencies that fall within a frequency range (Blocks 502, 504).

For example, the frequency range may include the range of frequencies from 400 KHz to 60 MHz, but this range may certainly vary depending upon, for example, the frequencies of the power generator(s) 102 that provide power to the system 100. The plurality of particular frequencies may be frequencies of a particular interest, and these frequencies, as discussed further herein, may also vary depending upon the frequencies of power that are applied to a processing chamber (e.g., processing chamber 104). For example, particular frequencies may be fundamental frequencies; second and third harmonics of each of the frequencies; and inter-modulation products of such frequencies.

As shown with reference to FIG. 4, the analog front end 406 of the first processing chain 402 is configured to receive a forward-voltage analog-RF signal from a transducer (not shown) and to prepare the analog-RF signal for digital conversion. The analog front end 406, for example, may include a voltage divider and pre-filter. As shown, once the analog-RF signal is processed by the analog front end 406, it is digitized by the A/D converter 408 to generate a stream of digital RF signals that includes the information indicative of electrical characteristics at the plurality of particular frequencies (Block 506). In some embodiments for example, 64 million samples are taken of the analog-RF signal per second with 14-bit accuracy.

As shown, once the sampled RF signals are digitized, the information indicative of electrical characteristics (in digital form) is successively transformed, for each of the plurality of particular frequencies, from a time domain into a frequency domain (Block 508). As an example, the transform portion 410 depicted in FIG. 4 receives the streams of digital RF signals 414, 416 and successively transforms the information in each of the digital streams 414, 416 from a time domain to a frequency domain, and provides both in-phase and quadrature information for both the forward voltage stream and the reflected voltage steam.

Although not required, the transform portion 410 in some embodiments is realized by a field programmable gate array (FPGA), which is programmed to carry out, at a first moment in time, a Fourier transform (e.g., a single frequency Fourier coefficients calculation) at one frequency, and then carry out a Fourier transform, at a subsequent moment in time, at another frequency so that Fourier transforms are successively carried out, one frequency at a time. Beneficially, this approach is faster and more accurate than attempting to take a Fourier transform over the entire range of frequencies (e.g., from 400 KHz to 60 MHz) as is done in prior solutions.

In the embodiment depicted in FIG. 4, the particular frequencies f_{1-N} at which successive transforms of the digital RF signals are taken are stored in a table 418 that is accessible by the transform portion 410. In variations of this embodiment, a user is able to enter the particular frequencies f_{1-N} (e.g., using the man-machine interface 114 or other input means). The particular frequencies f_{1-N} entered may be frequencies of interest because, for example, the frequencies affect one or more plasma parameters. As an example, if two frequencies are applied to a plasma chamber 104 (e.g., utilizing two generators), there may be 8 frequencies of interest: the two fundamental frequencies; the second and third harmonics of each of the frequencies; and the two inter-modulation products of the two frequencies.

In some embodiments, 256 samples of each of the digital streams 414, 416 are used to generate a Fourier transform, and in many embodiments the data rate of the digital streams 414, 416 is 64 Megabits per second. It is contemplated, however, that the number of samples may be increased (e.g., to improve accuracy) or decreased (e.g., to increase the rate at which information in the streams is transformed). Beneficially, in many implementations of the transform portion 410, the digital streams 414, 416 are continuous data streams (e.g., there is no buffering of the data) so that a transform, at each of the particular frequencies (e.g., frequencies f_{1-N}) is quickly carried out (e.g., every micro second).

As shown in the embodiment depicted in FIG. 4, the transform portion 410 provides two outputs (e.g., in-phase information (I) and quadrature information (Q)) for each of the digital forward and reflected voltage streams 414, 416, and each of the four values are then corrected by the correction portion 412. As depicted in FIG. 4, in some embodiments, correction matrices 420 are used to correct the transformed information from the transform portion 410. For example, each of the four values provided by the transform portion 410 are multiplied by a correction matrix that is stored in memory (e.g., non-volatile memory).

In many embodiments the matrices 420 are the result of a calibration process in which known signals are measured and correction factors are generated to correct for inaccuracies in a sensor. In one embodiment, the memory includes one matrix for each of 125 megahertz, and each of the matrices is a 2-by-4 matrix. In an alternative embodiment, a separate matrix is used for each of impedance and power; thus two hundred and fifty (250) 2-by-4 matrices are used in some embodiments.

As shown, after correction by the correction portion 412, four outputs, representing corrected, in-phase and quadrature representations of forward and reflected voltage, are provided as output.

In some embodiments, a look-up table (e.g., of sine and cosine functions) is used to carry out a Fourier transform in the transform portion 410. Although Fourier transforms may be carried out relatively quickly using this methodology, the amount of stored data may be unwieldy when a relatively high accuracy is required.

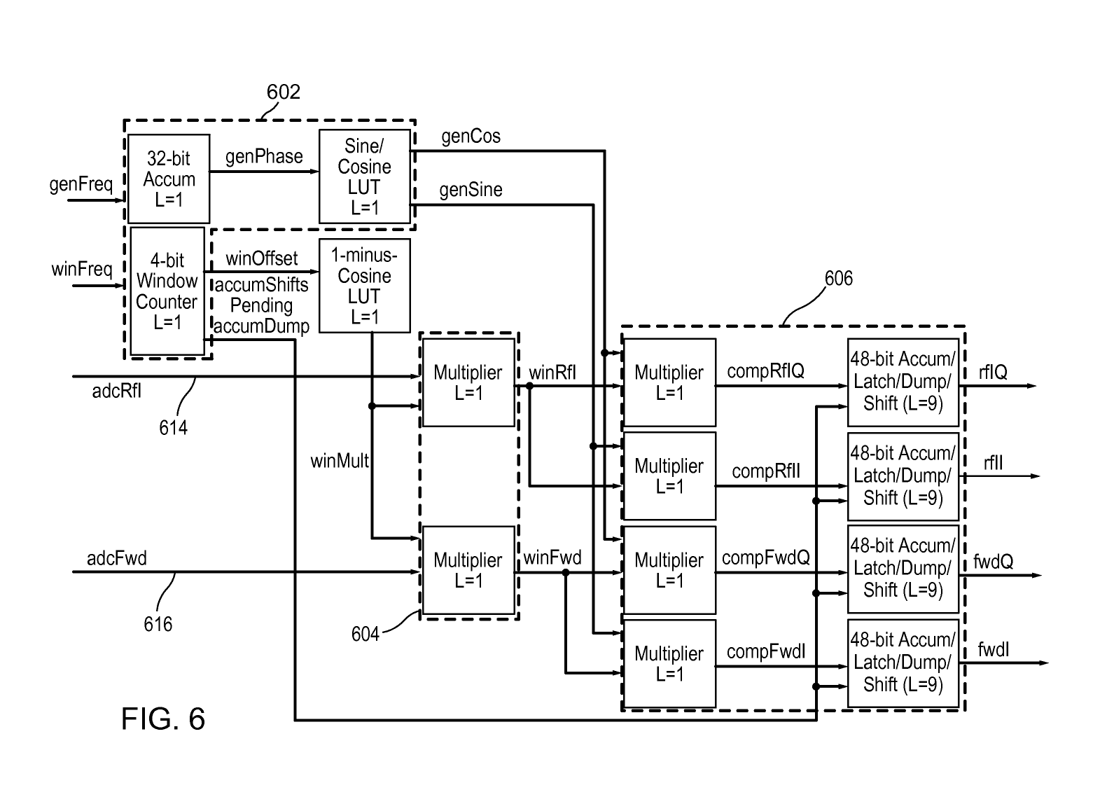

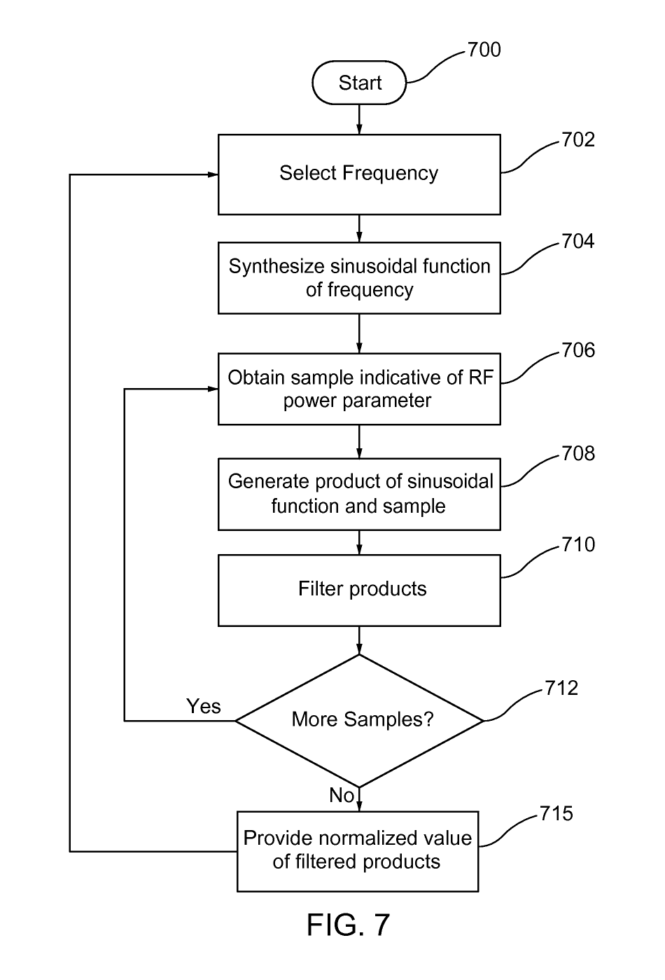

In other embodiments, direct digital synthesis (DDS) is used in connection with the transform of data. Referring to FIG. 6, for example, it is a block diagram depicting an exemplary embodiment of the transform portion 410 depicted in FIG. 4. While referring to FIG. 6, simultaneous reference will be made to FIG. 7, which is a flowchart depicting an exemplary method for performing a transform of sampled RF data. As shown, in the exemplary embodiment depicted in FIG. 6, a particular frequency is selected (e.g., one of the particular frequencies f_{1-N} described with reference to FIG. 4) (Blocks 700, 702), and a direct digital synthesis portion 602 synthesizes a sinusoidal function for the frequency (Block 704). In the embodiment depicted in FIG. 6, for example, both a sine and a cosine function are synthesized.

As shown, a sample indicative of an RF power parameter is obtained (Block 706). In the exemplary embodiment depicted in FIG. 6, digital samples 614, 616 of both forward and reflected voltage are obtained, but in other embodiments other parameters are obtained (e.g., voltage and current). As shown in FIG. 7, for each selected frequency, products of the sinusoidal function at the selected frequency and multiple samples of the RF data are generated (Block 708). In the embodiment depicted in FIG. 6 for example, after a windowing function 604 is carried out on the digital RF samples 614, 616 (e.g., obtained from the A/D converter), the sine and cosine functions generated by the DDS 602 are multiplied by each sample by multipliers in a single-frequency-Fourier-coefficients-calculation (SFFC) portion 606.

As shown, the products of the sinusoidal function and the samples are filtered (Block 710) (e.g., by accumulators in the SFFC 606), and once a desired number of digital RF samples are utilized (Block 712), a normalized value of the filtered products is provided (Block 715). In some embodiments, 64 samples are utilized and in other embodiments 256 are utilized, but this is certainly not required, and one of ordinary skill in the art will recognize that the number of samples may be selected based upon a desired bandwidth and response of the filter. In yet other embodiments other numbers of digital RF samples are utilized to obtain the value of a parameter (e.g., forward or reflected voltage) at a particular frequency.

As shown in FIG. 7, for each particular frequency (e.g., each of the N frequencies in table 718) Blocks 702-714 are carried out so that the transforms of the sampled RF data are successively carried out for each frequency of interest. In one embodiment, the DDS 602, windowing 604 and the SFFCC 606 portions are realized by an FPGA. But this is certainly not required, and in other embodiments the DDS portion 602 is realized by a dedicated chip (or application-specific integrated circuit (ASIC), for example) and the windowing 604 and SFFCC 606 portions are implemented separately (e.g., by an FPGA or ASIC).

A second portion of the present disclosure is directed to a method for determining (e.g., continuously, automatically, and autonomously) the frequency at which the power generator 102 is operating at any given time.

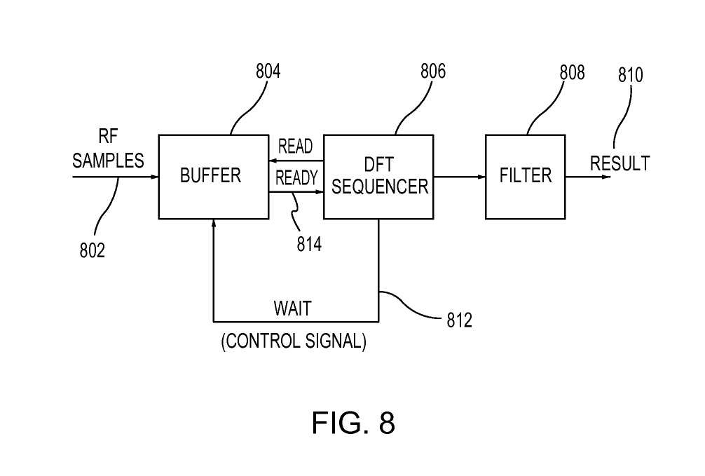

Referring next to FIG. 8, shown is an exemplary embodiment of a processing portion that may be implemented to determine the frequency at which the power generator 102 is operating. The depiction of components in FIG. 8 is logical (e.g., functional) and therefore not meant to be an actual hardware diagram. The components may be combined, allocated or further separated in an actual implementation. Moreover, the functions depicted in FIG. 8 may be implemented in hardware (e.g., in an ASIC or FPGA), in firmware (e.g., operating in embedded memory of a microcontroller or digital signal processor), or in software (e.g., operating in the analysis portion 108 as depicted in FIG. 1).

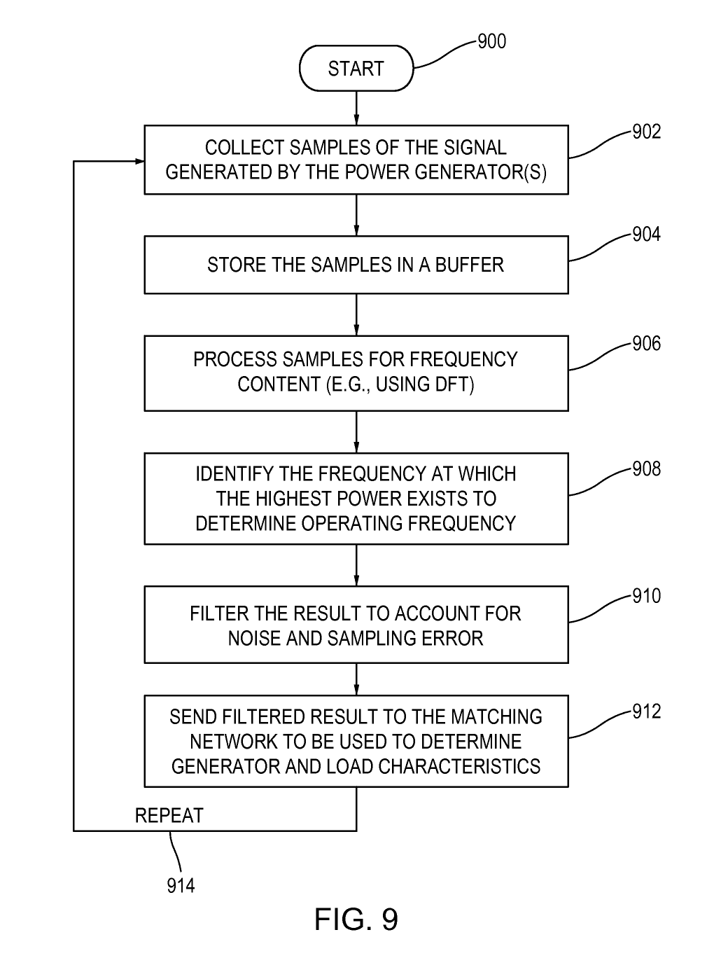

While referring to FIG. 8, simultaneous reference is made to FIG. 9, which is a flowchart 900 that depicts an exemplary method for determining the frequency at which the power generator 102 is operating at any given time. It should be recognized, however, that the method depicted in FIG. 9 is not limited to the specific embodiment depicted in FIG. 8.

As shown in FIGS. 8 and 9, a power signal (often an RF power signal) that is generated by a power generator 102 is sampled to obtain a set of samples 802 of the power signal that include information indicative of the operational frequency of power generator 102. Because the system 100 has a known range of operational frequencies, which is based on the specific application and materials used in the system 100, there is a known, predetermined minimum and maximum frequency that is relevant to the specific mode of operation. These minimum and maximum frequencies define the range of frequencies that are of interest. The algorithm takes the relevant range of frequencies, and divides that range into segments for purposes of detection (block 902).

Next a buffer 804 stores the samples 802 in preparation for processing (block 904). The buffer 804 is configured to provide status 814 of sufficient availability of data, and to receive a control signal 812 from a discrete Fourier transform (DFT) sequencer 806, and the control signal 812 indicates when the digital sequencer 806 is not ready to accept new data in the buffer 804.

The DFT sequencer 806 performs a sequence of transformations (DFTs) on the samples 802 to determine the frequency at which the highest level of power is contained in the signal. That frequency is deemed to be the frequency at which the power generator 102 is operating (blocks 906, 908). In one embodiment, the sequence of transformations can be selected to detect frequencies at a uniform interval between the minimum and maximum interval. In another embodiment, the sequence starts with a coarse interval and proceeds with finer intervals as the frequency range with highest power is narrowed.

The determined operational frequency might not be the actual operational frequency because the DFT sequencer's results depend on the frequencies at which the transformations are taken. Accordingly, a filtering component 808 is used to reduce the impact of error and noise on outcome. In one embodiment, the filter component 808 takes a fraction of the step between the current operational frequency and the detected operational frequency, to smooth out the transitions from frequency to frequency as the portion of the disclosed technology operates iteratively (block 910). In another embodiment, the filter 808 simply takes the midpoint between the frequencies corresponding to two adjacent sample points that have the highest power components. The filter 808 delivers a result 810 that is closer to the actual operating frequency of the power generator 102, and it rejects noise.

As shown, the filtered result 810 is then transmitted to the matching network 106 to be used by the matching network 106 to help accurately determine the characteristics of the system 100 (block 912). In particular, the result 810 is used to make accurate measurements of voltage, current and phase in the matching network, because the operating frequency of the power generator 102 must be known to make accurate measurements.

Once completed, the process repeats to update the system (block 914). Preferably, the process depicted in FIG. 9 is implemented such that the time to complete one cycle of the process is substantially faster than the time it takes the plasma chamber 104 and power generator 102 to change characteristics and operating frequency, respectively. As such, implementations in hardware (e.g., in an FPGA or ASIC) are advantageous because such implementations are relatively faster than other means of implementation.

A third portion of the present disclosure is directed to a method for determining (e.g., continuously, automatically, and autonomously) the frequency at which the power generator 102 is operating when the power generator 102 is operating in a pulsing mode.

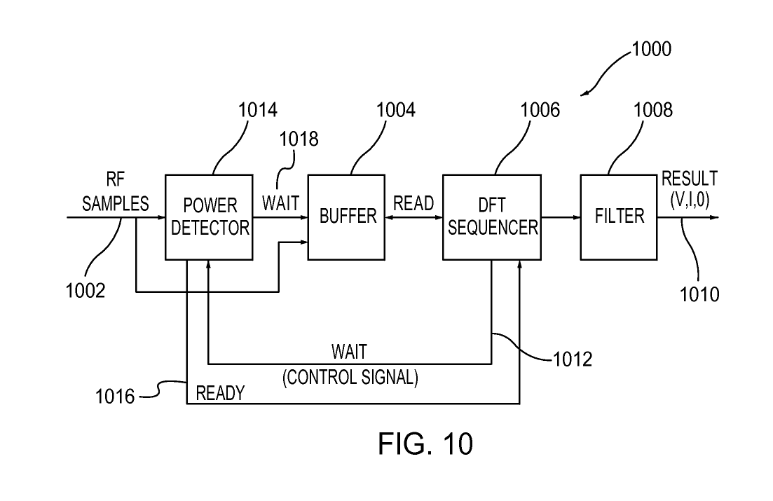

Referring next to FIG. 10, shown is an exemplary embodiment of a processing portion 1000 that may be implemented to determine the frequency at which the power generator 102 is operating when the power generator 102 is operating in a pulsing mode. The depiction of components in FIG. 10 is logical and therefore not meant to be an actual hardware diagram. The components may be combined, allocated or further separated in an actual implementation. Moreover, the functions depicted in FIG. 10 may be implemented in hardware (e.g., in an ASIC or FPGA), in firmware (e.g., operating in embedded memory of a microcontroller or digital signal processor), or in software (e.g., operating in the analysis portion 108 as depicted in FIG. 1).

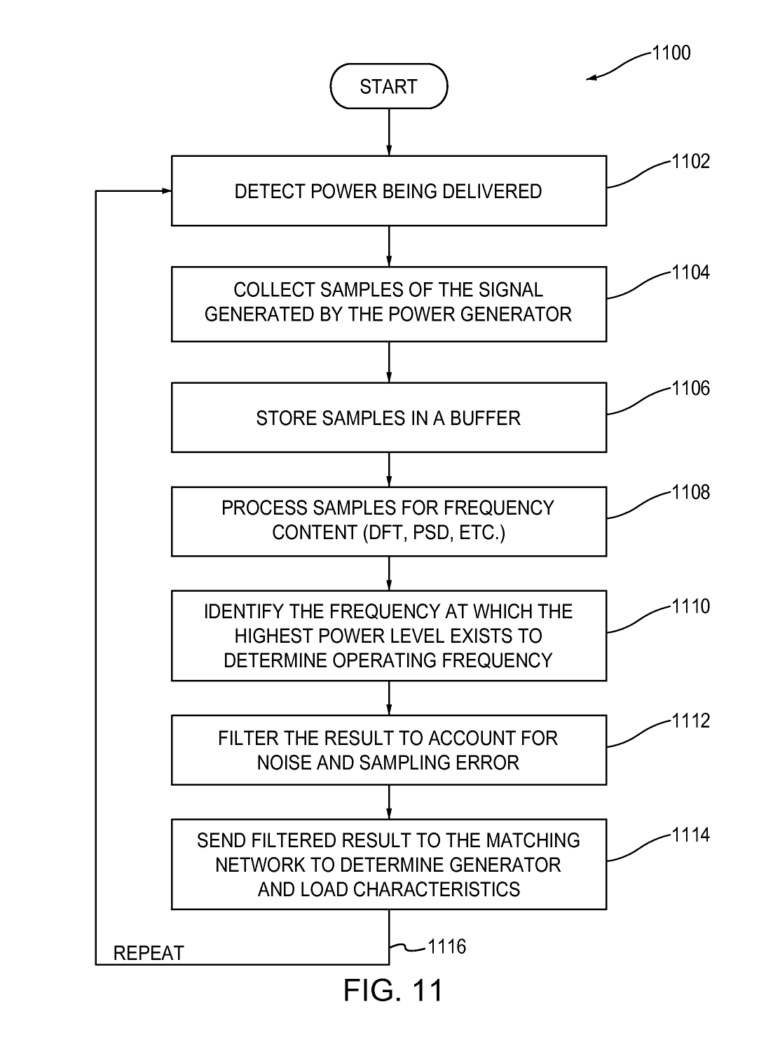

While referring to FIG. 10, simultaneous reference will be made to FIG. 11, which is a flowchart 1100 that depicts an exemplary method for determining the frequency at which the power generator 102 is operating at any given time when the power generator 102 is also operating in a pulsing mode. It should be recognized, however, that the method depicted in FIG. 11 is not limited to the specific embodiment depicted in FIG. 10.

As shown in FIGS. 10 and 11, a power signal (often an RF power signal) that is generated by the power generator 102 is transmitted to a power detector 1014 and a buffer 1004. The power detector 1014 detects whether or not the power signal is delivering power to the plasma chamber 104. The power detector 1014 may be embodied as described herein (relating to the first portion of the present disclosure, directed to a method for determining whether the power generator 102 is delivering a power signal into the plasma chamber 104 or whether the power generator 102 is not delivering a power signal to the plasma chamber 104) or it may be implemented through other means, including a basic sensing capability, for example, implementation of simple circuitry configured to send a control signal when it detects a power signal at its input. When power is detected, the power detector 1014 sends its control (or latch) signal to the buffer 1004 to indicate when the buffer 1004 should begin (and stop) storing data.

Next, the power signal (including frequency and RF power information) generated by the power generator 102 is sampled to obtain a set of samples of the power signal that include information indicative of the operational frequency of power generator 102. Because the system 100 has a known range of operational frequencies, which is based on the specific application and materials used in the system 100, there is a known, predetermined minimum and maximum frequency that is relevant to the specific mode of operation. These minimum and maximum frequencies define the range of frequencies that are of interest. In many implementations, the relevant range of frequencies is divided into segments for purposes of detection (block 1104).

Next a buffer 1004 stores the samples in preparation for processing (block 1106). The buffer 1004 is configured to receive a control signal 1018 from a power detector 1014. The power detector 1014 provides status 1016 of sufficient availability of data, and receives a control signal 1012 from a discrete Fourier transform (DFT) sequencer 1006. The control signal 1012 indicates when the DFT sequencer 1006 is ready to receive the next set of samples from the buffer 1004.

The DFT sequencer 1006 performs a sequence of transformations (DFTs) on the samples 1002 to determine the frequency at which the highest level of power is contained in the signal. That frequency is deemed to be the frequency at which the power generator 102 is operating (blocks 1108, 1110). In one embodiment, the sequence of transformations can be selected to detect frequencies at a uniform interval between the minimum and maximum interval. In another embodiment, the sequence starts with a coarse interval and proceeds with finer intervals as the frequency range with highest power is narrowed.

The determined operational frequency might not be the actual operational frequency because results from the DFT sequencer 1006 depend on the frequencies at which the transformations are taken. Accordingly, a filtering component 1008 is used to reduce the impact of error and noise on outcome. In one embodiment, the filter component 1008 takes a fraction of the step between the current operational frequency and the detected operational frequency to smooth out the transitions from frequency to frequency as the portion of the disclosed technology operates iteratively (block 1112). In another embodiment, the filter 1008 simply takes the midpoint between the frequencies corresponding to two adjacent sample points that have the highest power components. The filter 1008 delivers a result 1010 that is closer to the actual operating frequency of the power generator 102, and it rejects noise. (Block 1112)

Finally, the filtered result 1010 is transmitted to the matching network 106 to be used by the matching network 106 to help accurately determine the characteristics of the plasma processing system 100 (block 1114). In particular, the result 1010 is used to make accurate measurements of voltage, current, and phase in the matching network, because the operating frequency of the power generator 102 must be known to make accurate measurements.

Once completed, the process repeats to update the system (block 1116). Preferably, the process depicted in FIG. 11 is implemented such that the time to complete one cycle of the process is substantially faster than the time it takes the plasma chamber 104 and power generator 102 to change characteristics and operating frequency, respectively. As such, implementations in hardware (e.g., in an FPGA or ASIC) are advantageous because such implementations are relatively faster than other means of implementation.

In conclusion, the present disclosed technologies provide, among other things, methods and apparatuses for measuring electrical characteristics of power that is applied to a plasma processing chamber when a power generator operates in a pulsing mode, when a power generator operates in a variable frequency mode, and when a power generator operates in both a pulsing mode and in a variable frequency mode concurrently. Those skilled in the art can readily recognize that numerous variations and substitutions may be made in the disclosed technologies, their use and the configurations to achieve substantially the same results as achieved by the embodiments described herein. Accordingly, there is no intention to limit the technologies to the disclosed exemplary forms herein. Many variations, modifications and alternative constructions fall within the scope and spirit of the disclosed technologies as expressed in the claims. Additionally, there are illustrated and described herein specific structures and details of operation, and it is plainly understood that the same were disclosed merely for purposes of illustration, and that changes and modifications may be readily made therein by those skilled in the art without departing from the spirit and the scope of the novel technology disclosed herein.

We claim:

1. A system for measuring characteristics of power being applied to a plasma processing chamber comprising:
a power generator configured to generate a power signal, the power generator being configurable to operate in a pulsing mode, configurable to operate in a variable frequency mode, and configurable to operate in both a pulsing mode and a variable frequency mode concurrently;
a plasma processing chamber coupled to the power generator;
a matching network coupled to the power generator and coupled to the plasma processing chamber, the matching network configurable to adjust its impedance in response to changes of a characteristic of the plasma processing chamber;
a pulse state detector coupled to the power generator and coupled to the matching network; and
a frequency detector coupled to the power generator, and coupled to the matching network.

2. The system of claim 1 wherein the pulse state detector comprises:
a power signal amplitude detector configured to detect the state of the power generator when the power generator operates in a pulsing mode; and
a filter configured to discard portions of the power signal amplitude detected by the amplitude detector, which discarded portions may be affected by a confounding event.

3. The system of claim 2 wherein the confounding event includes noise, interference during transition from one pulsing state to another pulsing state, and delay.

4. The system of claim 1 wherein the pulse state detector comprises:
a power detector configured to detect the state of the power generator when the power generator operates in a pulsing mode; and
a filter configured to discard portions of the power signal amplitude detected by the amplitude detector, which discarded portions may be affected by a confounding event.

5. The system of claim 4 wherein the confounding event includes noise, interference during transition from one pulsing state to another pulsing state, and delay.

6. The system of claim 1 wherein the frequency detector comprises:
a buffer coupled to the power generator, the buffer being configured to receive a power signal and being configured to store the received power signal for a predetermined period of time;
a frequency component sequencer coupled to the buffer, the frequency component sequencer being configured to receive the stored power signal from the buffer when the frequency component sequencer delivers a control signal to the buffer indicating that the frequency component sequencer is ready to receive and process the stored power signal; and
a filter coupled to the frequency component sequencer, the filter being configured to reduce the impact of frequency detection error.

7. The system of claim 1 further comprises a digital sampler coupled between the power generator and the buffer.

8. The system of claim 7 wherein the frequency component sequencer comprises a discrete Fourier transform processor.

9. A method for autonomously measuring characteristics of a power signal generated by a power generator, the power signal being applied to a plasma processing chamber, the method comprising:
detecting when a power signal is being delivered to the plasma chamber corresponding to a pulse-on state of operation of the power generator;
identifying a primary operating frequency of the delivered power signal;
determining a plurality of characteristics of the power generator and of the plasma chamber; and
adjusting a matching network in response to the determined plurality of characteristics of the power generator and of the plasma chamber.

10. The method of claim 9 further comprising filtering the identified primary operating frequency of the delivered power signal to account for noise and sampling error.

11. The method of claim 9 wherein detecting when a power signal is being delivered to the plasma chamber, corresponding to a pulse-on state of operation of the power generator comprises:
measuring the amplitude of the delivered power signal;
determining whether the measured amplitude is above or below a predetermined threshold;
determining whether the measured signal is near a transition between a pulse-on state and a pulse-off state; and
discarding the measurement if the measurement is determined to be near a transition state and declaring a state change, or using the measurement as an accurate indication of the power signal if the measurement is determined not to be near a transition state.

12. The method of claim 11 wherein determining whether the measured signal is near a transition between a pulse-on state and a pulse-off state comprises comparing the present measurement as well as a predetermined or configurable number of previous measurements and a predetermined or configurable number of subsequent measurements.

13. The method of claim 9, including:
obtaining samples of the power signal;
grouping the samples into a plurality of measurement groups so that each of the measurement groups includes a plurality of individual samples;
discarding one or more measurement groups that follow detection of the pulse-on state; and
using the measurement groups that are not discarded to measure a characteristic of the power signal during the pulse-on state.

14. The method of claim 13, wherein the quantity of discarded measurement groups is programmed in advanced based upon prior knowledge of the power signal.

15. The method of claim 13, wherein the quantity of discarded measurement groups is dynamically determined based upon whether particular ones of the measurement groups fall outside a calculated variance.

16. The method of claim 9 wherein identifying a primary operating frequency of the delivered power signal comprises:
collecting and storing a plurality of samples of the delivered power signal;
processing the collected and stored samples of the delivered power signal for various frequency components within a predefined range of frequencies;
identifying the frequency component at which the highest level of power within the sampled power signal exists; and
filtering the result to account for noise and sampling error.

17. A method for determining the frequency at which a power generator is operating when the power generator is operating in a pulsing mode, the method comprising:
detecting when a power signal is being delivered to the plasma chamber, corresponding to a pulse-on state of operation of the power generator, comprising:
measuring the amplitude of the delivered power signal;
determining whether the measured amplitude is above or below a predetermined threshold;
determining whether the measured signal is near a transition between a pulse-on state and a pulse-off state;
discarding the measurement if the measurement is determined to be near a transition state and declaring a state change; and
using the measurement as an accurate indication of the power signal if the measurement is determined not to be near a transition state;
identifying a primary operating frequency of the delivered power signal, comprising:
collecting and storing a plurality of samples of the delivered power signal;
processing the collected and stored samples of the delivered power signal for various frequency components within a predefined range of frequencies;
identifying the frequency component at which the highest level of power within the sampled power signal exists; and
filtering the result to account for noise and sampling error;
determining a plurality of characteristics of the power generator and of the plasma chamber; and
adjusting a matching network in response to the determined plurality of characteristics of the power generator and of the plasma chamber
